(19) United States
(12) Patent Application Publication
(10) Pub. No.: US 2002/0103792 A1
(43) Pub. Date: Aug. 1, 2002

(54) Acumatch cross-matching system

(76) Inventors: Arthur Blank, Encinitas, CA (US); Len Schiedel, Encinitas, CA (US)

Correspondence Address: Royal W. Craig, Law Offices of Royal W. Craig, Suite 1319, 210 N. Charles St., Baltimore, MD, 21201, US

(21) Appl. No.: 09/775,986

(22) Filed: Feb. 2, 2001

Related U.S. Application Data
(60) Provisional application No. 60/180,094, filed on Feb. 3, 2000.

(51) Int. Cl. G06F 7/00

(52) U.S. Cl. 707/3

(57) ABSTRACT

A system and method for cross-matching a query record with a database of registration records. The method begins by compiling a database of registration records each identifying and describing actual characteristics of an entity. Once the registration database is compiled, the database may be queried by inputting a query record describing desired characteristics of an entity. The query record includes a plurality of incremental preference rankings associated with the desired characteristics. Given the registration database and a query record, the cross-matching engine of the present invention will cross-match the actual characteristics with the desired characteristics by assigning a score for each match that is weighted in accordance with the preference ranking. The scores are totaled to prioritize the closest registration records based on the query record. The present method provides a statistical cross-matching system that accurately accounts for user-preferences. The system is described in the context of an on-line dating service.

### CROSS-REFERENCE TO RELATED APPLICATIONS

The present application derives priority from U.S. Provisional Patent Application 60/180,094 for “ACUMATCH CROSS-MATCHING SYSTEM”; Filed: Feb. 3, 2000;

### BACKGROUND OF THE INVENTION

1. Field of the Invention

The present invention relates to information management and, more particularly, to a robust, accurate and fully automated cross-matching system.

2. Description of the Background

Traditional statistical cross-matching techniques generally involve element-by-element matching of data components with a percentage correlation output. However, such techniques are not well-suited for matching of subjective data because the importance of any given data element may outweigh another. For example, dating services claim to have matching capabilities, but none of these services are capable of weighting their subscriber's preferences. Thus, it makes no difference that a given subscriber places more emphasis on the hair color of a potential match rather than weight.

There have been a few attempts to provide close-match capabilities. For example, U.S. Pat. No. 5878416 discloses an automated system and method for matching an item of business property to a recipient.

U.S. Pat. No. 6073130 discloses a method for improving the results of a search in a structured database using weighted matching. The system identifies a plurality of records which each minimally match a search query. Each identified record is then assigned a weight based on at least two factors: the extent to which the record matches the entire search query; and the relative frequency with which the attribute/value pair that matches the given record matches the records of the remainder of the structured database. The plurality of records that minimally match the search query are then identified to the requester in ranked order based on the assigned weights.

While the foregoing illustrates a form of weighted matching, there are no known solutions for weighted matching based on user-preference (including user-defined weights). Consequently, there is a significant demand for a robust, accurate and fully automated cross-matching system that can implement weighted matching to account for the subjective preferences of the searcher.

### SUMMARY OF THE INVENTION

In accordance with the above, it is an object of the present invention to provide a statistical cross-matching system that accurately accounts for user-preferences.

In accordance with the above-described object, the present invention provides a system and method for cross-matching a query record with a database of registration records. The method begins by compiling a database of registration records each identifying and describing actual characteristics of an entity. Once the registration database is compiled, the database may be queried by inputting a query record describing desired characteristics of an entity. The query record includes a plurality of incremental preference rankings associated with the desired characteristics. Given the registration database and a query record, the cross-matching engine of the present invention will cross-match the actual characteristics with the desired characteristics by assigning a score for each match that is weighted in accordance with the preference ranking. The scores are totaled to prioritize the closest registration records based on the query record.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a screen print of an exemplary login screen of the present invention.

FIG. 2 is a screen print of the Profile Definition window.

FIG. 3 is a screen print of the Profile Data Entry window.

FIG. 4 is an exemplary “I AM” input record completed in accordance with the entry procedure screens of FIGS. 1-3.

FIG. 5 is a screen print of the picture file entry window.

FIG. 6 illustrates the “I WANT” data entry screen that appears if the user depresses the Physical primary category and Height subcategory .

FIG. 7 is an exemplary “I WANT” query record.

FIG. 8 is a perspective block diagram of the simple method of matching according to the present invention.

FIG. 9 is a results display including prioritized list of potential matches.

FIG. 10 is a detailed listing of a potential match.

FIG. 11 is a perspective block diagram of the advanced search that matches the user's “I AM” self-profile data with the entire library of “I WANT” query data, plus the user's “I WANT” query data with the entire library of “I AM” self-profile data.

FIG. 12 is a prioritized list of potential matches.

FIG. 13 is a screen print of the editing screen whereby the user can preview/edit their registration record.

FIG. 14 is a screen print of the record preview screen

FIG. 15 is a screen print of the status window.

### DETAILED DESCRIPTION OF THE PREFERRED EMBODIMENT

The present invention is an information management system for finding all matches that fit a given query. The system employs a cross-matching engine that calculates the weighting of preferences stated by an individual and is thereby capable of weighted matching of characteristics of people, places, merchandise, books, gifts, etc. The cross-matching engine can find and/or report on near-matches based on rank preferences and percent of accuracy. The cross-matching system comprises a registration procedure by which each user completes an entry record or “profile” comprising a self-description of “I AM”, as well as a section of “I WANT” information reflecting the information reflecting the characteristics of the person that the user is searching for. Both the “I WANT” information and “I AM” information includes an unlimited number of categories each with an unlimited number of subcategories, and unlimited choices per sub-category. Each sub-category may allow only a single choice or any combination of choices (such as, for instance, all, either one of, any of, or none).

Once installed and initiated, the computer program of the present invention guides a user quickly through a series of steps in which all “I AM” and “I WANT” characteristics, preferences and desires are defined, assembled, compiled and analyzed. During each step in the process the user is presented with simple graphical interfaces that provide all of the software tools necessary to define and assemble a complete registration record. A primary advantage of the invention lies in its intuitive organization and flow, e.g., all necessary choices and other data are defined by the user and stored in a library (the library being arranged in layers corresponding to the level of detail of the component). Then, additional or different data components may be added to the library as desired. While the information management system of the present invention is applicable across a wide variety of information management applications, it will herein be described in the context of an on-line dating service.

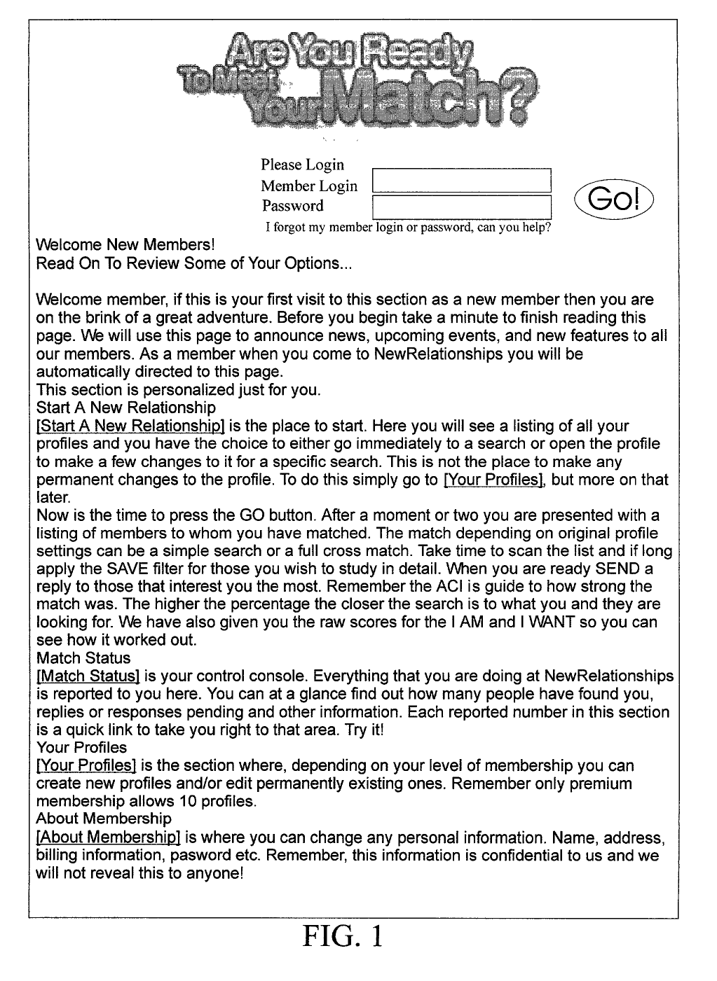

FIGS. 1, 2, 3 and 6 illustrate the navigable series of online registration forms that guide a user quickly through entry of all “I WANT” and “I AM” physical and social characteristics.

As shown in FIG. 1, each new user must register with the system by entering their member login ID and password. This information is submitted by pressing the GO! button. The login screen of FIG. 1 also provides a text overview and links to the other sections of the online site.

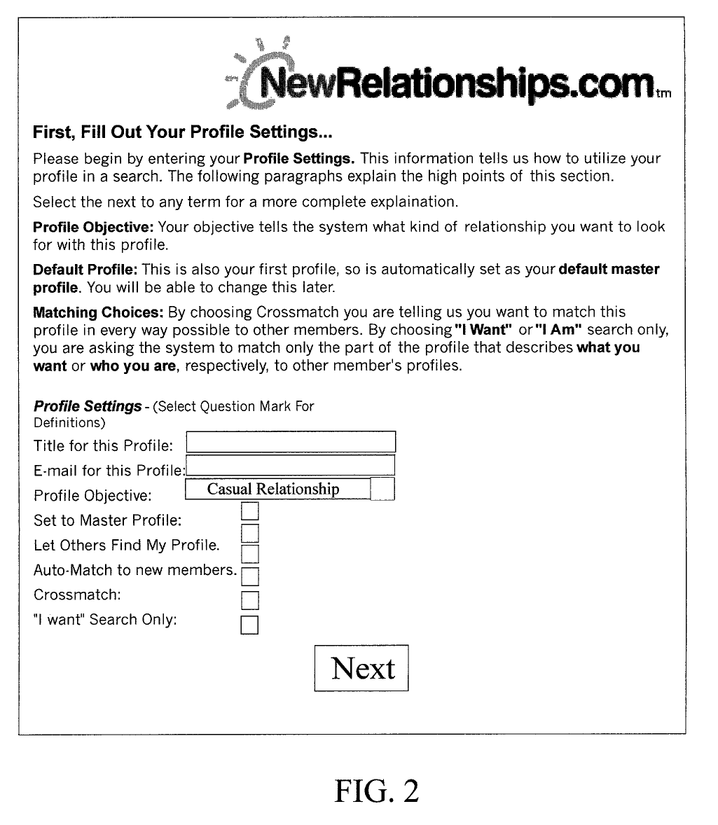

Once logged in and/or registered, the user is presented with the Profile Definition screen of FIG. 2. Here the user is prompted to enter text fields for a new profile in the corresponding text windows. The text fields include a Title for the profile and an email address for the user. In addition, the user then selects an Objective for the relationship that they are searching for. The objective is entered from a number of predetermined choices in a drop-down selection window (at center). Exemplary choices include: Casual Relationship, Serious Relationship, Casual Sex, Matrimony, Friendship, Travel Destination Buddy, Discrete/intimate. A number of check-box information items are also solicited including Set to Master Profile, Let Others Find My Profile, Auto-Match to New Members, Cross-Match, “I Am” Search Only, and “I Want” Search Only. These information items impose optional constraints on how the system will use the profile. Specifically, Set to Master Profile causes the system to use this profile as a master template to facilitate the user in setting up multiple profiles. Let Others Find My Profile makes the current profile searchable and accessible by other users. Auto-Match to New Members causes the cross-matching algorithm of the present invention to auto-initiate upon each new member login. The “I Am” Search Only and “I Want” Search Only limits the cross-matching capabilities of the present invention to a simple search based on a user's “I WANT” profile characteristics versus an advanced search based on cross-matching of “I WANT” profile needs and “I AM” profile characteristics, respectively, as will be described. The default is an advanced search for Crossmatch, or both types of matching. The information is entered and can be saved by pressing the NEXT button at the bottom. When the NEXT button is pressed, the registration record is saved to a database library of registration profiles.

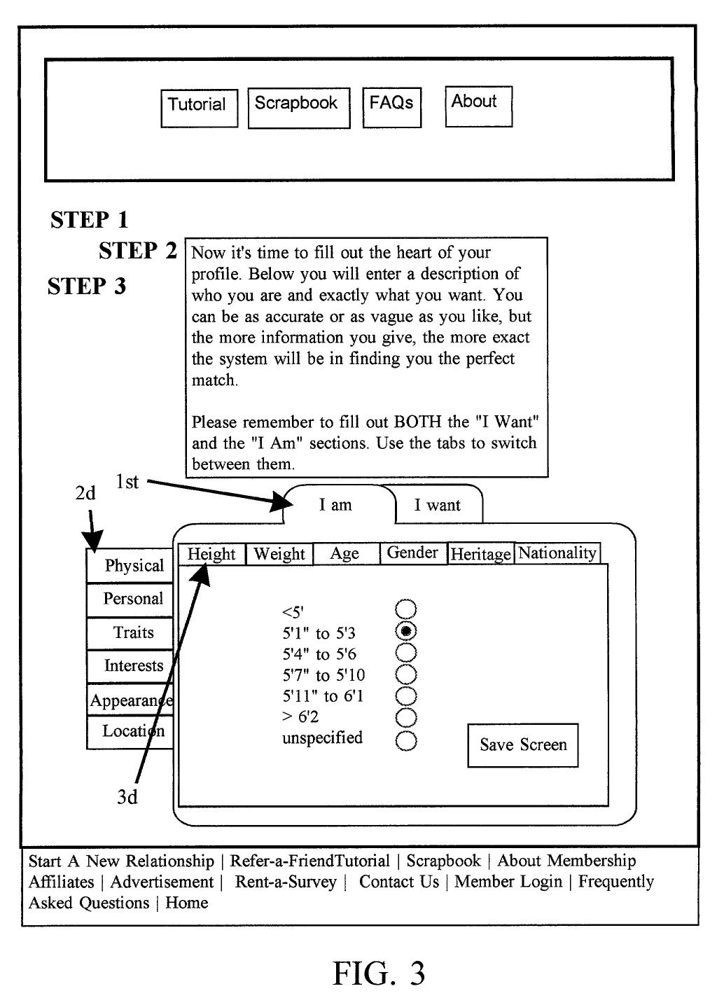

The user is then presented with the screen of FIG. 3 and is confronted at the bottom portion of the screen with a navigable profile portfolio which allows them to efficiently enter all “I WANT” and “I AM” physical and social characteristics for their profile. First (as shown by the arrow), the “I AM” category is selected by clicking on the “I AM” binder tab at top (next to the “I WANT” tab). A series of category buttons appear to the left that will lead the user through a tree-like array of categories, and choices within the categories. The cross-matching engine allows an unlimited number of categories each with an unlimited number of subcategories, and unlimited choices per sub-category. In the present dating context, exemplary primary categories include the following: Physical, Personal, Traits, Appearance and Location. All are represented by corresponding index tabs to the left. Second (as shown by the arrow), pushing any of these button tabs will bring up a lower level of push-buttons representing the relevant subcategories. Each lower level of subcategory push-buttons appears directly beneath the upper level “I WANT” and “I AM” buttons. For example, if the user depresses Physical an array of physical subcategory tabs are listed inclusive of the following: Gender, Heritage, Height, Weight, Age, Nationality. Each sub-category may allow only a single choice or any combination of choices (such as, for instance, all, either one of, any of, or none). Third (as shown by the arrow), when the user depresses the Height button he is confronted with a check box data entry form with incremental choices for Height, each choice representing a range of height such as <5′, 5′1″ to 5′3″, 5′4″ to 5′6″, 5′7″ to 5′10″, 5′11″ to 6′1″, >6′2″, and unspecified. Any one of the check boxes may be chosen to indicate the user's height, and the selection is saved by depressing the “SAVE SCREEN” button at right.

Likewise, when the user depresses the Weight button he is confronted with a check box data entry form with choices for Weight, each choice representing a range of weight such as: <100 lbs., 100-109 lbs., 110-119 lbs, and upward by 9 pound increments. The selection is saved by depressing the “SAVE SCREEN” button at right.

When the user depresses the Age button he is confronted with a check box data entry form with incremental choices for age, each choice representing a range of age such as 20-23, 24-27, and upward by 4 year increments. The selection is saved by depressing the “SAVE SCREEN” button at right.

When the user depresses the Gender button he is confronted with a check box data entry form at the center of the portfolio with choices for Female, Male, and Unspecified. Any one or none of the check boxes may be chosen to indicate the user's gender. The selection is saved by depressing the “SAVE SCREEN” button at right.

When the user depresses the Heritage button he is confronted with a check box data entry form with choices for African, Latin, East Indian; Asian, Native American, and Caucasian. The selection is saved by depressing the “SAVE SCREEN” button at right.

When the user depresses the Nationality button he is confronted with an option either to fill in a text box or to select from a drop-down list. The drop-down list includes such choices as African, Latin, East Indian; Asian, Native American, Caucasian. The selection is saved by depressing the “SAVE SCREEN” button at right.

The user then proceeds to the next primary category, which is the Personal category. Upon selecting the Personal category the following sub-category buttons appear: Marital Status; Sexual Preference; Dependents; Occupation; Religion.

When the user depresses the Marital Status button he is confronted with a check box data entry form with the following choices for Marital Status: Married, Divorced, Never Married, Unspecified, Widowed, Single, Separated.

When the user depresses the Sexual Preference button he is confronted with a check box data entry form with the following choices for Sexual Preference: Bi-sexual, Hetero; Unspecified, Celibate, Gay.

When the user depresses the Dependants button he is confronted with a check box data entry form with the following choices for Dependants: Children with me, Children not with me, Never had children, Unspecified.

When the user depresses the Occupation button he is confronted with a check box data entry form with the following choices for Occupations: Unemployed, In business, clergy, Unspecified, Student, Civil Service, Actor, Professional, Artist, Athlete.

When the user depresses the Religion button he is confronted with a check box data entry form with a range of choices for Religion: Catholic, Jewish, Mormon, Episcopal, Lutheran, etc.

When the user depresses the Traits button he is confronted with a lower level of push-buttons marked with a range of personal trait subcategories inclusive of: Smoke; Drink; Gamble; Social; Charitable; Volunteer. When the user depresses the Smoke button he is confronted with a check box data entry form with a range of choices for smoking: Chain Smoker, Sometime Smoker, Non-smoker, Unspecified. Depressing the Drink button yields a check box data entry form with a range of choices including the following: Heavy, Occasional, Non, Unspecified. Depressing the Gamble button yields a check box data entry form with a range of choices including the following: Big drinker, Social Drinker, Heavy Social, Average, Don't drink, Unspecified. Depressing the Charitable button yields a check box data entry form with a range of choices including the following: Large, Average, Non-charitable, Unspecified. Depressing the Volunteer button yields a check box data entry form with a range of choices including the following: Heavy, Average, Don't, Unspecified. If the user depresses the Appearance button he is confronted with a lower level of push-buttons marked with a range of appearance subcategories inclusive of: Hair Color; Eye Color; Build; Looks; Hair Style; Facial Hair. Depressing the Hair Color button yields a check box data entry form with a range of choices including the following: Blond, Brown, Red, Grey, etc. Depressing the Eye Color button yields a similar check box data entry form with choices such as Blue, Brown, Green, Unspecified. Depressing the Build button yields a check box data entry form with choices such as: Petite, Extra Pounds, Slim, Buff, Average, Unspecified. Depressing the Looks button yields a similar check box data entry form with choices such as: Plain, Striking, Average, above Average, Unspecified. Depressing the Hair Style button yields a similar check box data entry form with a variety of hair style choices. Likewise, depressing the Facial Hair button yields a check box data entry form with choices such as: None, Goatee, Mustache, Full Beard, Unspecified.

The user then proceeds to the next category, which is the Location category. Upon selecting the Location category the following buttons appear: City; State; Country; Zip. When the user depresses the City button he is confronted with an option either to fill in a text box with his city, or to select from a drop-down list. The drop-down list includes various city choices. Depressing either the State or Country push-button yields a similar option either to fill in a text box, or to select from a drop-down list. Depressing the Zip button opens a text box for typing in the zip code.

After traversing the registration procedure all “I AM” information necessary to compile a self-profile entry record has been entered. Of course, the content of the information may vary depending on the application, and an unlimited number of categories may exist, each with an unlimited number of subcategories, and unlimited choices per sub-category.

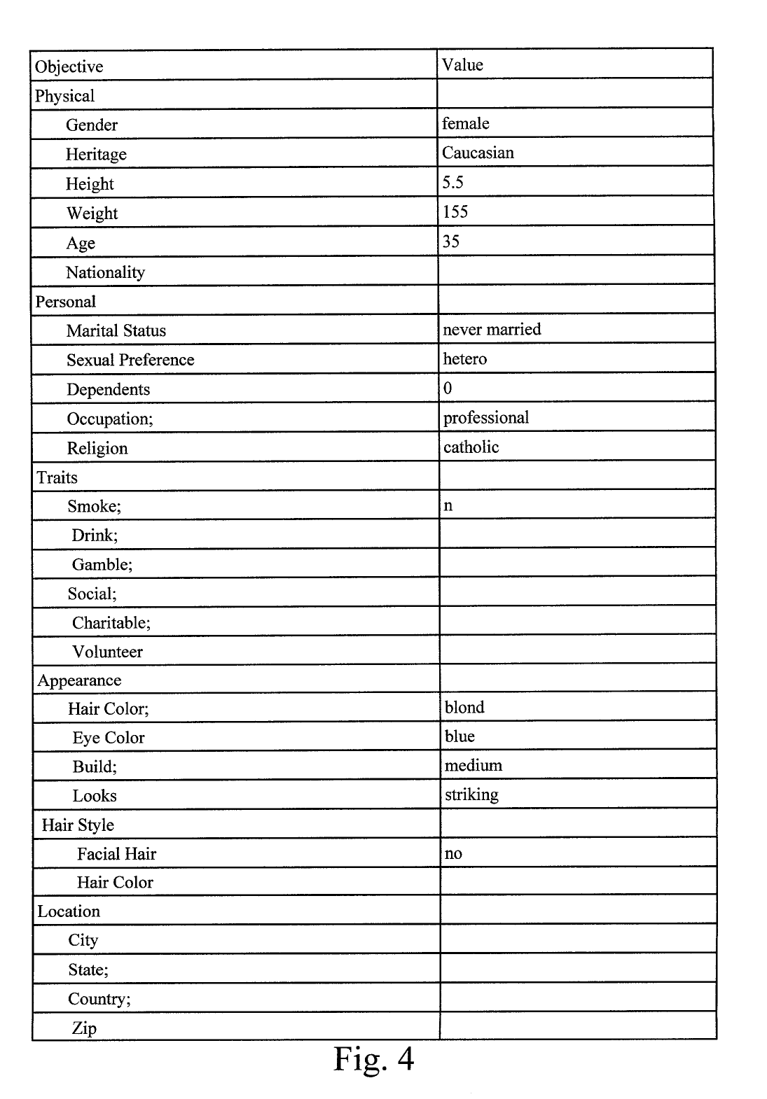

FIG. 4 illustrates the format of an exemplary user “I AM” input record completed in accordance with the entry procedure of FIGS. 1-3.

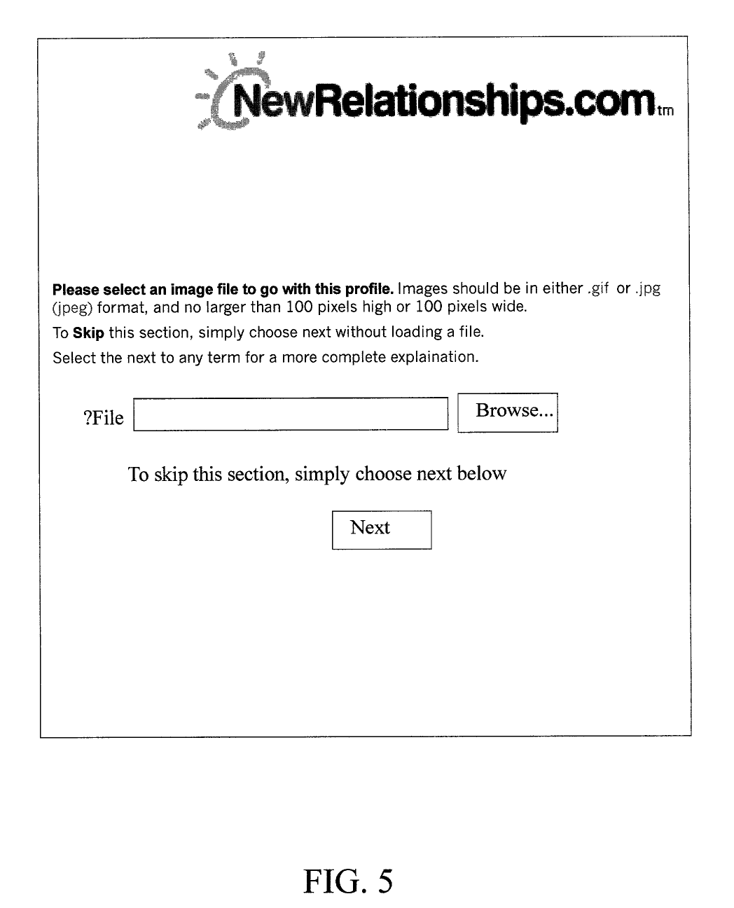

After completing the “I AM” input record the user is led to the screen of FIG. 5 which allows the user to upload or specify an address location of a picture file of themselves (in either .gif or .jpg format). A NEXT (or Submit) button at bottom allows the image to be associated is with the user profile for access by others. Alternatively, this step can be skipped.

After entering a picture file of themselves the user may optionally enter a short paragraph describing themselves, or other relevant information as desired. Finally, the user is notified that the profile is completed and is assigned an ad tracking number.

Given a library of self-profiles entered as above, any user can query the library for compatible profiles by entering his or her “I WANTS” preferences describing the type of person that they seek. This is accomplished in almost exactly the same way described above in regard to FIG. 3, and is initiated simply by pressing the “I WANT” tab thereof. It is noteworthy that the user “I AM” self-profile information will be entered at the outset and will remain substantially unchanged throughout multiple uses of the system. It is envisioned that the present invention will be offered as a service to paying members. When a member first registers for the service, they will complete their own “I AM” profile. They may then revisit the service multiple times, each time posting a new profile, and at each posting fill in a new “I WANTS” registration to search for different types of people that they are looking for.

In navigating the “I WANTS” registration, the user is again confronted with a series of category buttons that will lead them through a tree-like array of categories, and choices within the categories. The engine allows an unlimited number of categories each with an unlimited number of subcategories, and unlimited choices per sub-category. For user desires, exemplary primary categories include the same Physical, Personal, Traits, Interests, Appearance and Nationalities categories. Pushing any of these buttons will bring up a lower level of push-buttons representing the relevant subcategories, and each lower level of push-buttons appears directly beneath the upper level “I AM” and “I WANT” buttons. For each subcategory of information the user selects their desired characteristic. In addition, the user assigns a preference level for each characteristic.

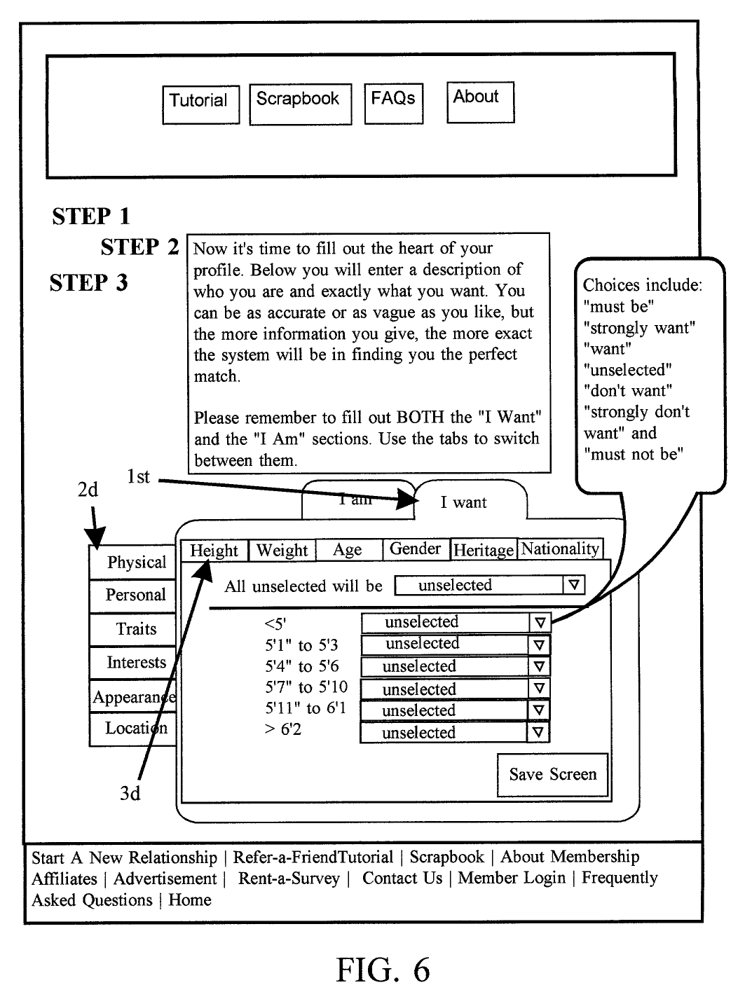

For example, FIG. 6 illustrates the “I WANT” data entry screen that appears if the user depresses the Physical primary category and Height subcategory. A range of discrete choices are given at left, for instance, <5′, 5′-5′2″, 5′3″-5′5″, etc. For each choice, a drop down box or other data entry means is provided to allow the user to specify a preference levels for that choice. Specific choices may be as follows: must be; strongly want; want; don't care (or “unselected”, e.g., no preference); don't want; strongly don't want; must not be. The default preference value is “unselected”. However, the user can override the default value as shown by selecting an alternative in response to the prompt “All unselected will be.” Once all desired choices are made numerical values are assigned to the preference levels as follows: require=1; strongly want to be=2; want to be=3; “unselected” (don't care)=4; don't want=5; strongly don't want=6; must not be=7. Thus, by traversing the graphical user “I WANT” interface the user profiles the type of person that they seek and ranks each preference item. After traversing the “I WANT” registration procedure most all information necessary to compile a query record will have been entered, thereby reflecting the searcher's rank preference for each characteristic.

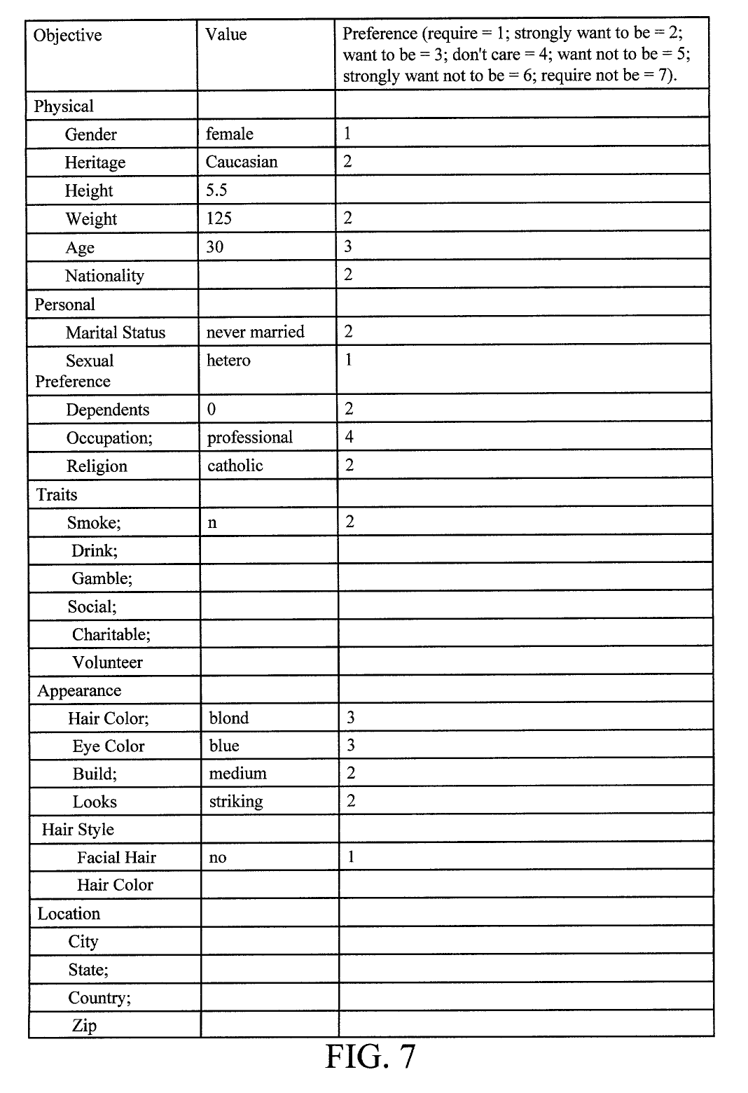

FIG. 7 illustrates the format of an exemplary “I WANT” query record completed in accordance with the above. For each user, all of their “I WANT” query records are linked to their singular “I AM” self-profile. Given a complete library of profiles and a query records entered per the above, the searcher can submit his query for matching.

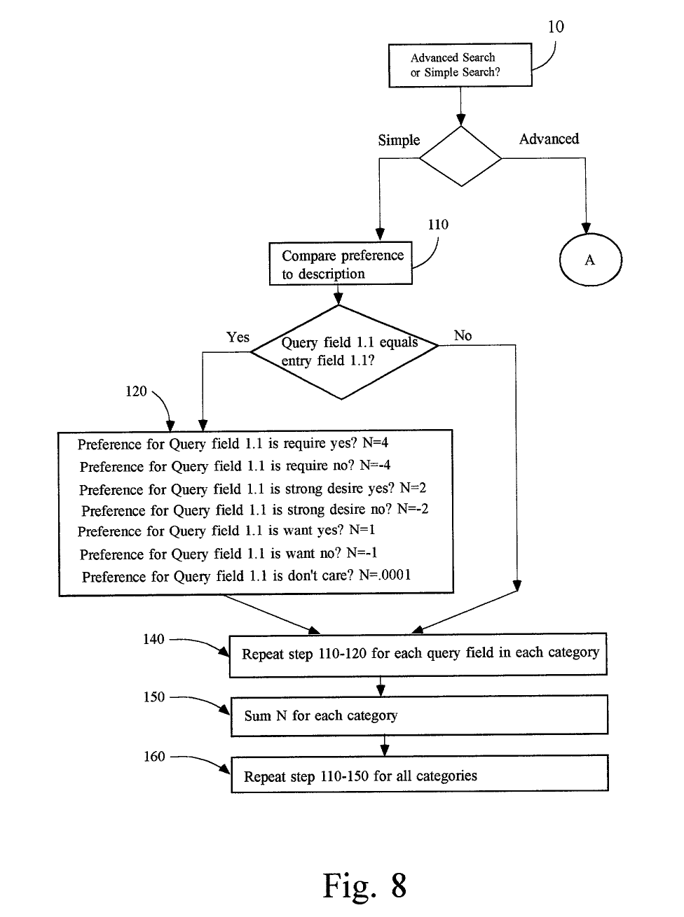

FIG. 8 is a perspective block diagram of the method of cross-matching according to the present invention. At step 10 the system decides whether to employ an advance search or a simple search. A simple search matches one user's query record data fields (FIG. 7) to another user's registration record's fields (FIG. 4). Each category is scored by comparing preference to description. Positive comparisons result in scoring as shown at step 120. For instance, if the searcher had indicated that his or her preference level for a given field of data is a positive “must be” at step 110, then a positive comparison (the query data equals the profile record) will proceed to step 120 and a score of 4 will be assigned. Likewise, if the searcher indicates a negative “must not be”, then a score of 4 is assigned when the entry record does not equal the query data. A positive “must be” in the query where the other record is not, or a negative “must not be” that is, scores 4 but also disqualifies the match. A “strongly want” where the other record is, or a “strongly don't want” that isn't, scores a 2. A “strongly want” where the other record is not, or “a strongly don't want” that is, scores a zero. A “want” where the other record is, or a “don't want” that isn't, scores a 1. A “want” where the other record is not, or a “don't want” that is, scores a zero. An “unspecified” (or “don't care”) where the other record matches scores 0.001, and this is designed to sort above an unspecified field of data in either the query record or profile record. An unspecified field of data in either the query record or profile record generally scores a 0, although the user may be given the option of assigning a different meaning to an unspecified field of data as shown by the drop-down window labeled “An Unselected will be . . . ” overhead.

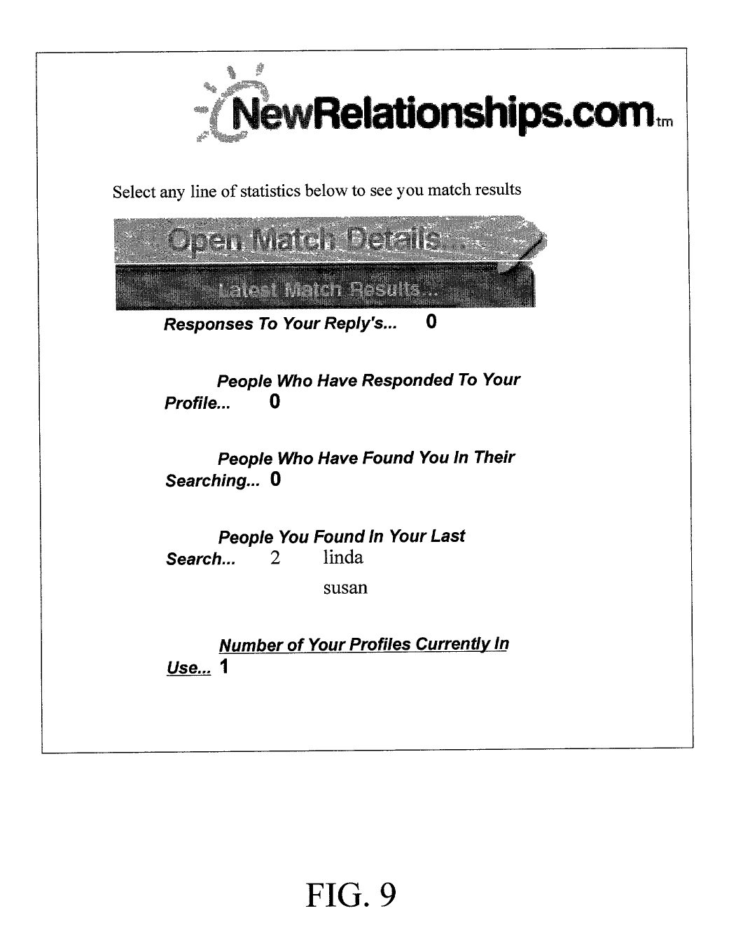

The ratios of each numeric score (searchers preferences versus registration record) to the maximum possible score (if all matched) are averaged together for each category and are expressed as a percentage. In our example, a numeric score of +3 out of a possible 6 in the Physical category gives a ratio of 50%. Each individual score per category is totaled to give an overall numeric score for searcher's wants. Any records with no positive matches are culled out of the match list. The scores are used to sort the match list, although the matching method does not order strictly based on absolute scores. Thus, a record with many query preferences a few of which match input record preferences will score lower than a query record with few preferences that all match. A perfect but simple match will rank higher than a complicated near mismatch. Overall, this results in more accurate searches, and superior culling of mismatches to simplify the list without culling possible good matches. The resulting percentage score also makes rankings easier to understand instead of a cryptic numeric score. The searcher is presented with a results display including the following information and as shown in FIG. 9:

| | | |
|---|---|---|
| Responses To Your Reply's . . . | 0 (to be | |
| | described) | |
| People Who Have Responded To Your Profile . . . | 0 (to be | |
| | described) | |
| People Who Have Found You In Their Searching . . . | 0 | |
| People You Found In Your Last Search . . . | 2 | linda |
| | | susan |
| Number of Your Profiles Currently In Use . . . 1 | | |

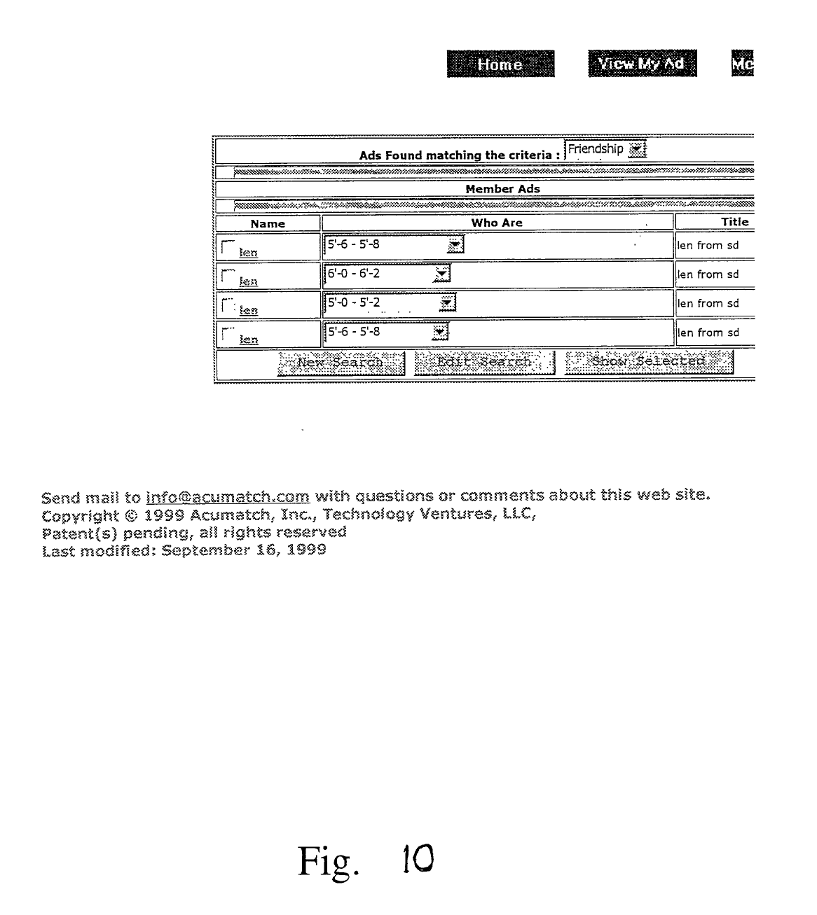

The searcher may then click one or more of the matches (linda or susan) for more detail. This will bring up a screen such as shown in FIG. 10, wherein the searcher is given an email icon and is presented with the option of corresponding with a given match. Each time that they do, the category “Responses To Your Reply's . . . ” shown in FIG. 9 will be incremented and a link will be provided to allow the user to read the responses. Likewise, each time that someone else conducts a matching session that identifies the user, the category “People Who Have Found You In Their Searching” will be incremented. If someone else sends an unsolicited message following their own search, the category “People Who Have Responded To Your Profile . . . ” shown in FIG. 9 will be incremented and a link will be provided to allow the user to read the messages. This provides an efficient interface to allow users to communicate on the basis of the present matching system.

In accordance with the business method of the present invention, all of the foregoing services are offered free of charge. A nominal charge may be levied to searchers who initiate contact. A possible revenue stream will come from advertising and/or from making a database of users and preferences available to advertisers.

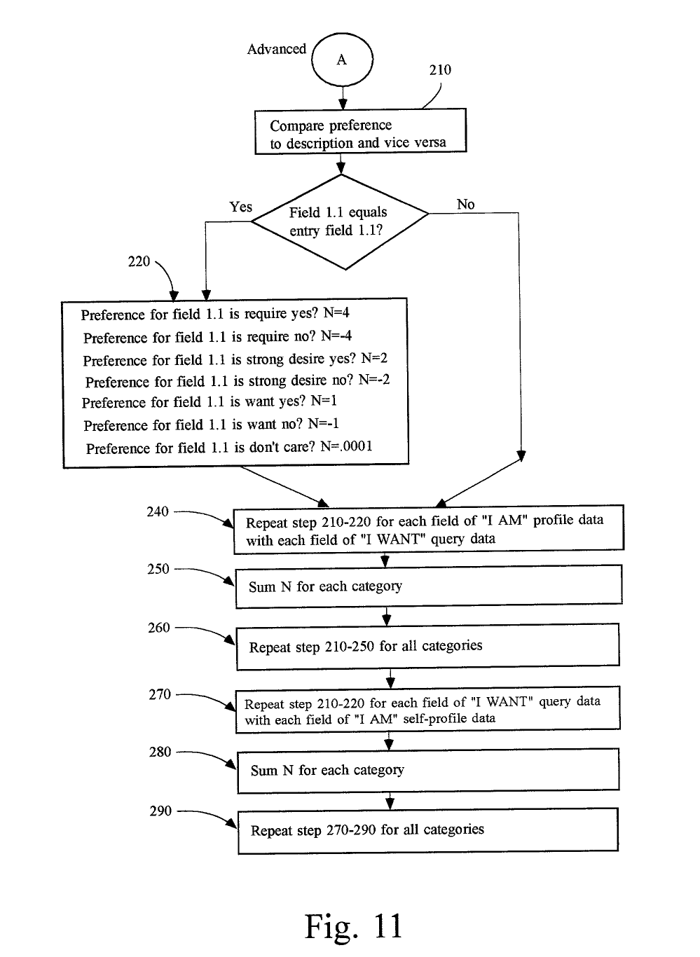

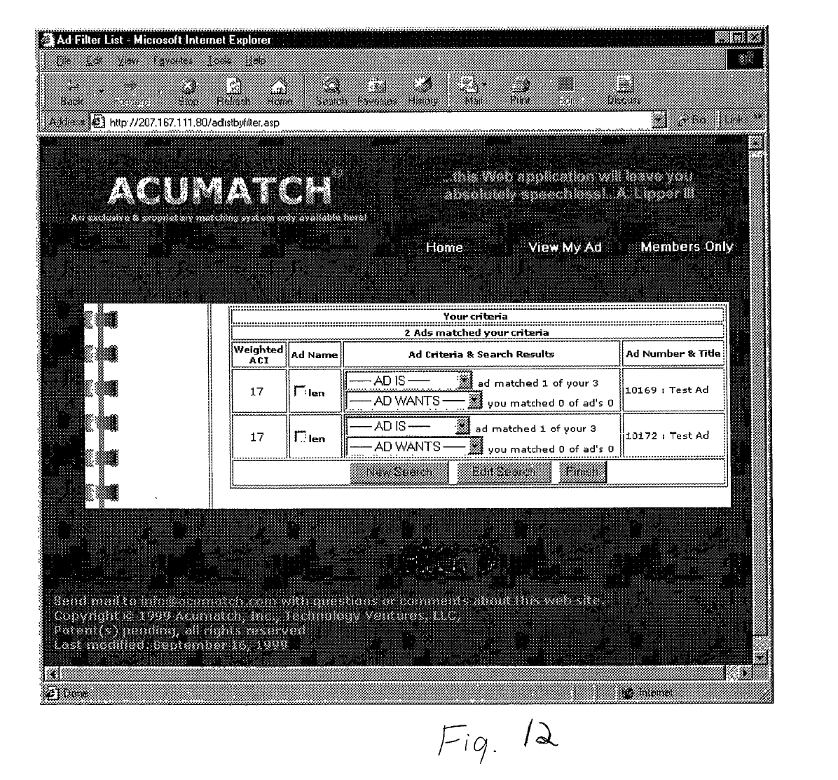

Referring back to FIG. 8, if at step 10 the user had decided to employ an advanced search rather than a simple search, program flow proceeds to FIG. 11. An advanced search matches the user's “I AM” self-profile data with the entire library of “I WANT” query data by recursively executing steps 240-260, and then it matches the user's “I WANT” query data with the entire library of “I AM” self-profile data by recursively executing steps 270-290. In both cases, each category is scored by comparing preference to description, and vice versa. Comparisons are scored as before and as shown at step 220. Each individual score per category is totaled to give an overall numeric score called the weighted ACI. Any records with no positive matches are culled out of the match list. The scores are used to sort the match list, and the searcher is presented with a prioritized list of potential cross-matches as shown in FIG. 12.

FIG. 12 is a prioritized list of potential matches from the advanced search of FIG. 11.

The above-described cross-matching method gives not only the simple matching of a search, but a cross-match of how well the search themselves matches each record.

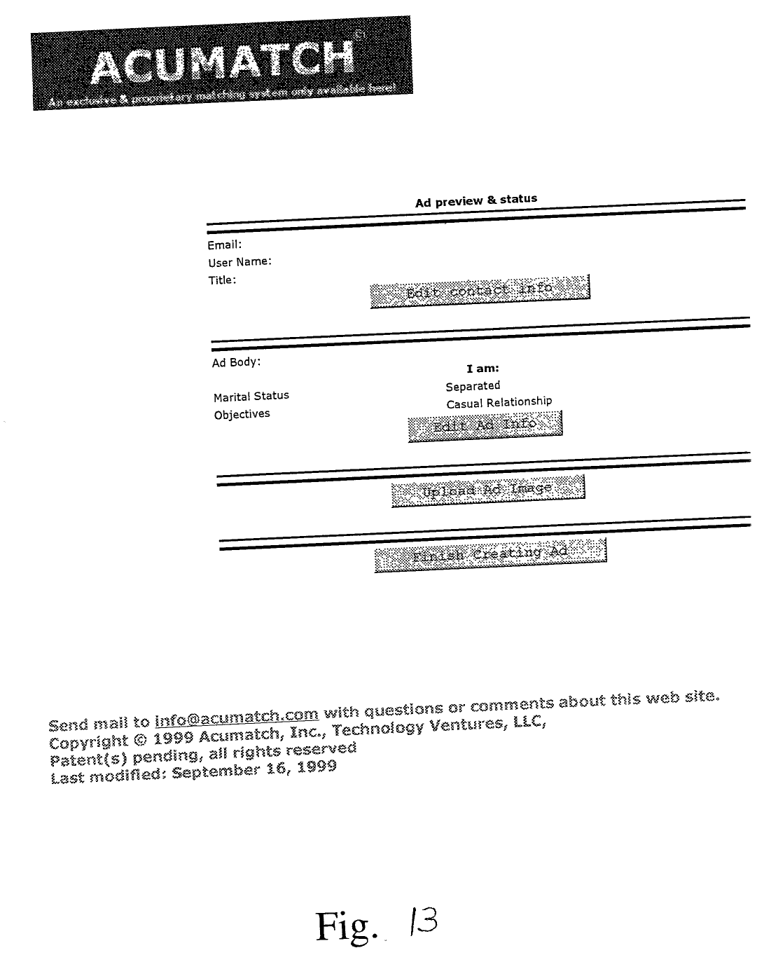

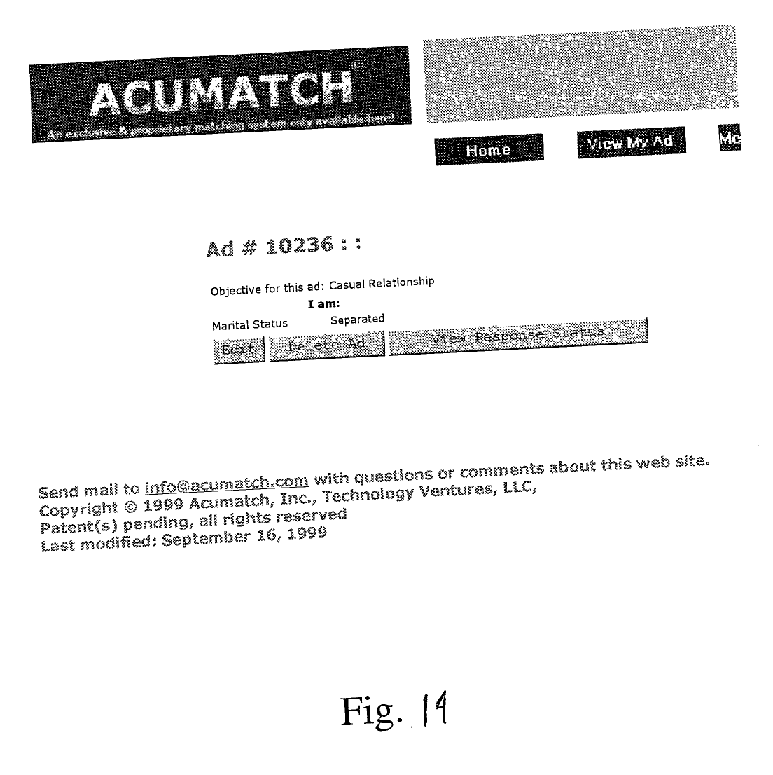

A series of auxiliary screens allows user maintenance of their account and registration information, and their user profiles. For example, FIG. 13 illustrates an editing screen whereby the user can preview their registration record. Push-buttons are provided to allow editing of contact information, registration record information, to upload an image, or to finish creating the registration record. When the latter button is depressed the screen of FIG. 14 arises. This screen shows the record number (Ad #10236), the objective for the profile (Casual Relationship), the Marital Status (Separated), and the Response Status.

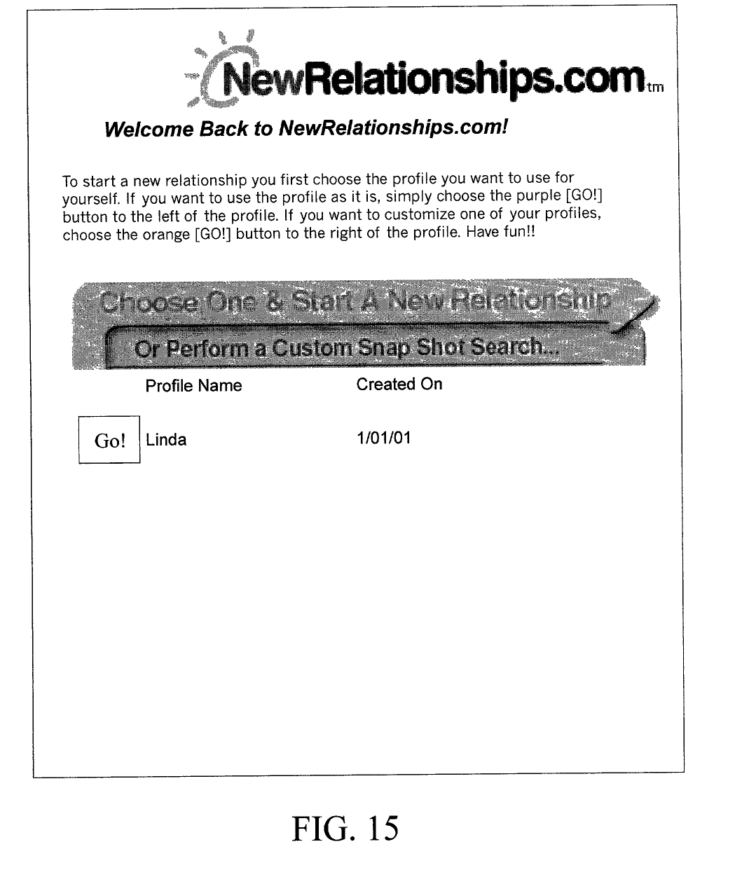

Each time a registered user returns and logs back onto the website they are greeted with a “welcome back” screen as shown in FIG. 15, which indicates the status of their record and associated profiles.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A method for matching one set of wants with a database of profiles based on cross-matching of corresponding want data to profile data, comprising the steps of:
compiling a database of registration records each identifying and describing actual characteristics of an entity;
compiling a query record describing desired characteristics of an entity, said query record including a plurality of incremental preference rankings associated with said desired characteristics;
matching said actual characteristics with said desired characteristics by assigning a score for each match that is weighted in accordance with said preference ranking;
totaling said scores to prioritize the closest registration records based on said query record.

2. The method for matching one set of wants with a database of profiles according to claim 1, wherein said step of matching said actual characteristics with said desired characteristics further comprises assigning a score for each non-match that is weighted in accordance with said preference ranking.

3. The method for matching one set of wants with a database of profiles according to claim 1, wherein said database of registration records identify and describe actual characteristics of people, and said step of compiling a database of registration records further comprises prompting successive users to each enter a profile of objective data identifying and describing themselves by a series of online forms presented to said users by a computer.

4. The method for matching one set of wants with a database of profiles according to claim 3, wherein said step of compiling a query record describing desired characteristics of an entity further comprises prompting a user to enter subjective data identifying and describing their wants by a series of online forms presented to said user by a computer, plus prompting said user to enter a subjective preference ranking associated with each want data element to indicate importance thereof.

5. The method for matching one set of wants with a database of profiles according to claim 4, wherein said step of compiling a query record further comprises prompting a user to enter subjective data identifying and describing their wants by a series of online forms displaying a range of discrete choices for each data element, plus a range of user-selectable preference levels for each data element.

6. The method for matching one set of wants with a database of profiles according to claim 5, wherein said user-selectable preference levels further comprise at least seven discrete preference levels substantially corresponding to “must”, “strongly want”, “want”, “don't care or no preference”, “don't want”, “strongly don't want” and “must not be”.

7. The method for matching one set of wants with a database of profiles according to claim 5, wherein said user-selectable preference levels are assigned numerical values.

8. The method for matching one set of wants with a database of profiles according to claim 6, wherein said user-selectable preference levels are assigned numerical values.

9. The method for matching one set of wants with a database of profiles according to claim 8, wherein said assigned numerical values are as follows: “must”=1, “strongly want”=2, “want”=3, “don't care or no preference”=4, “don't want”=5, “strongly don't want”=6 and “must not be”=7.

10. The method for matching one set of wants with a database of profiles according to claim 8, wherein said step of matching said actual characteristics with said desired characteristics by assigning a score for each match that is weighted in accordance with said preference ranking is further comprises assigning a maximum score for each positive comparison of query data with profile record when said preference ranking is equivalent to “must” or “must not be”.

11. The method for matching one set of wants with a database of profiles according to claim 10, wherein said step of matching said actual characteristics with said desired characteristics by assigning a score for each match that is weighted in accordance with said preference ranking further comprises assigning a minimum score for each positive comparison of query data with profile record when said preference ranking is equivalent to “don't care or no preference”.

12. An automated system for matching a set of desired subjective characteristics to a most suitable profile of actual objective characteristics from among a database of such objective profiles, comprising:
a database of profile records each comprising a collection of data elements describing actual objective characteristics of an entity;
a succession of computer forms navigable by a graphical user interface for prompting a user to enter a query record describing desired characteristics of an entity, said query record including a plurality of incremental preference rankings associated with said desired characteristics;
a computer software matching engine for scoring the conformity of the query record of desired characteristics with said profile records of actual characteristics based on correspondence of said data records as statistically weighted by said preference rankings, said matching engine then totaling said scores;
an output display for displaying a list of profile records that conform to said query record in prioritized order of the matching engine score.

13. The automated system for matching a set of desired subjective characteristics to a most suitable profile of actual objective characteristics according to claim 12, wherein said computer software matching engine assigns a numerical score for each match that is weighted in accordance with said preference ranking.

14. The automated system for matching a set of desired subjective characteristics to a most suitable profile of actual objective characteristics according to claim 13, wherein said computer software matching engine assigns a numerical score for each non-match that is weighted in accordance with said preference ranking.

15. The automated system for matching a set of desired subjective characteristics to a most suitable profile of actual objective characteristics according to claim 13, wherein said profile records each identify and describe actual characteristics of people.

16. The automated system for matching a set of desired subjective characteristics to a most suitable profile of actual objective characteristics according to claim 15, wherein said query records include subjective data identifying and describing a user's wants plus a subjective preference ranking associated with each want to indicate importance thereof.

17. The automated system for matching a set of desired subjective characteristics to a most suitable profile of actual objective characteristics according to claim 17, wherein said succession of computer forms prompts a user to enter subjective data identifying and describing their wants by displaying a range of discrete choices for each data element, plus a range of user-selectable preference levels for each data element.

18. The automated system for matching a set of desired subjective characteristics to a most suitable profile of actual objective characteristics according to claim 17, wherein said user-selectable preference levels further comprise at least seven discrete preference levels substantially corresponding to “must”, “strongly want”, “want”, “don't care or no preference”, “don't want”, “strongly don't want” and “must not be”.

19. The automated system for matching a set of desired subjective characteristics to a most suitable profile of actual objective characteristics according to claim 17, wherein said user-selectable preference levels further comprise at least seven discrete preference levels.

20. An online matching method, comprising:
prompting each user to enter a personal profile comprising information describing actual characteristics of the user, characteristics desired by said user, and incremental preference rankings associated with said desired characteristics;
matching said actual characteristics with said desired characteristics by assigning a score for each match that is weighted in accordance with said preference ranking;
totaling said scores to prioritize the closest registration records based on said query record.
